(19) United States
(12) Patent Application Publication
(10) Pub. No.: US 2008/0126748 A1
(43) Pub. Date: May 29, 2008

(54) Multiple-Core Processor

(76) Inventors: Louis B. Capps, Georgetown, TX (US); Ronald E. Newhart, Essex Junction, VT (US); Michael J. Shapiro, Austin, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/469,550

(22) Filed: Sep. 1, 2006

(51) Int. Cl. G06F 9/318; G06F 15/76

(52) U.S. Cl. 712/30; 712/E09.035

(57) ABSTRACT

A method, apparatus, and computer program product for using a multi-core integrated circuit to extend the reliability or operating life of an electronic device.

### BACKGROUND

1. Technical Field of the Present Invention

The present invention generally relates to processors and, more specifically, to processors having more than one core.

2. Description of Related Art

The appetite of the consumer for faster, smaller, and smarter electronic devices has pushed the semiconductor industry to innovate on several different aspects.

One particular area has been the design of processors. In the past, these designs where able to keep pace with the demands of the consumer by increasing the transistor count and the frequency at which the processor operates. Recently, however, the ability to increase this frequency has been limited by current process technology and geometries. As a result, multi-core functional units are now being used as a means to increase processor performance within the imposed frequency limitations. An example of a multi-core processor is the PowerPC™ 970MP by IBM™.

In addition, the industry has focused on increasing the reliability and life expectancy of a system as companies are now factoring these elements into their cost analysis.

It would, therefore, be advantageous if a multi-core device could be used in a manner so as to increase the reliability and lifetime of the system.

### SUMMARY OF THE PRESENT INVENTION

In one aspect, the present invention is a method of using one or more cores in an integrated circuit. The method includes the steps of selecting one or more of the cores for initial operation, and tracking the use of the selected core(s). The method also includes the step of swapping the selected core(s) with the remaining non-selected core(s) after the tracked use has exceeded a predetermined number.

### BRIEF DESCRIPTION OF THE DRAWINGS

The present invention will be better understood and its advantages will become more apparent to those skilled in the art by reference to the following drawings, in conjunction with the accompanying specification, in which:

FIG. 1 is a block diagram illustrating a computer system that implements a preferred embodiment of the present invention;

FIG. 2 is a diagram illustrating the processor of FIG. 1 in greater detail according to a preferred embodiment of the present invention;

FIG. 3 is a flow chart illustrating the method for managing the activation of cores C1-C4 when a predetermined amount of usage has occurred according to the teachings of a preferred embodiment of the present invention; and

FIG. 4 is a flow chart illustrating the method for managing the activation of cores C1-C4 of FIG. 2 when one of the cores C1-C4 has failed according to the teachings of a preferred embodiment of the present invention.

### DETAILED DESCRIPTION OF THE PREFERRED EMBODIMENT OF THE PRESENT INVENTION

The present invention is a method, system, and computer program product for using multiple cores in an integrated circuit. The present invention selects one or more of the cores for operating for a timed duration and then swaps one or more of the cores with one or more of the non-selected cores for operation during the remaining life of the integrated circuit.

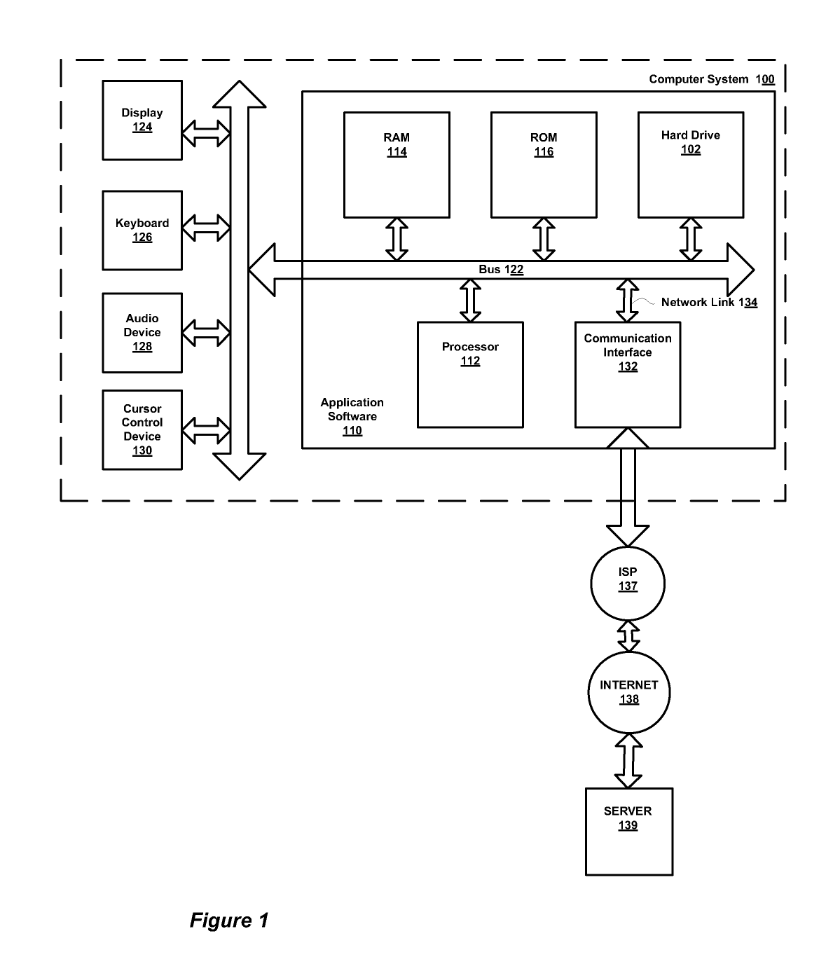

Reference now being made to FIG. 1, a block diagram is shown illustrating a computer system 100 that implements a preferred embodiment of the present invention. Computer System 100 includes various components each of which are explained in greater detail below.

Bus 122 represents any type of device capable of providing communication of information within Computer System 100 (e.g., System bus, PCI bus, cross-bar switch, etc.)

Processor 112 can be a general-purpose processor (e.g., the PowerPC™ 970 manufactured by IBM or the Pentium™ manufactured by Intel) that, during normal operation, processes data under the control of an operating system and application software 110 stored in a dynamic storage device such as Random Access Memory (RAM) 114 and a static storage device such as Read Only Memory (ROM) 1 16. The operating system preferably provides a graphical user interface (GUI) to the user.

The present invention, including the alternative preferred embodiments, can be provided as a computer program product, included on a machine-readable medium having stored on it machine executable instructions used to program computer system 100 to perform a process according to the teachings of the present invention.

The term “machine-readable medium” as used in the specification includes any medium that participates in providing instructions to processor 112 or other components of computer system 100 for execution. Such a medium can take many forms including, but not limited to, non-volatile media, and transmission media. Common forms of non-volatile media include, for example, a floppy disk, a flexible disk, a hard disk, magnetic tape, or any other magnetic medium, a Compact Disk ROM (CD-ROM), a Digital Video Disk-ROM (DVD-ROM) or any other optical medium whether static or rewriteable (e.g., CDRW and DVD RW), punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the preferred embodiment, an example of a non-volatile medium is the Hard Drive 102.

Volatile media includes dynamic memory such as RAM 114. Transmission media includes coaxial cables, copper wire or fiber optics, including the wires that comprise the bus 122. Transmission media can also take the form of acoustic or light waves, such as those generated during radio wave or infrared data communications.

Moreover, the present invention can be downloaded as a computer program product where the program instructions can be transferred from a remote computer such as server 139 to requesting computer system 100 by way of data signals embodied in a carrier wave or other propagation medium via network link 134 (e.g., a modem or network connection) to a communications interface 132 coupled to bus 122.

Communications interface 132 provides a two-way data communications coupling to network link 134 that can be connected, for example, to a Local Area Network (LAN), Wide Area Network (WAN), or as shown, directly to an Internet Service Provider (ISP) 137. In particular, network link 134 may provide wired and/or wireless network communications to one or more networks.

ISP 137 in turn provides data communication services through the Internet 138 or other network. Internet 138 may refer to the worldwide collection of networks and gateways that use a particular protocol, such as Transmission Control Protocol (TCP) and Internet Protocol (IP), to communicate with one another. ISP 137 and Internet 138 both use electrical, electromagnetic, or optical signals that carry digital or analog data streams. The signals through the various networks and the signals on network link 134 and through communication interface 132, which carry the digital or analog data to and from computer system 100, are exemplary forms of carrier waves transporting the information.

In addition, multiple peripheral components can be added to computer system 100. For example, audio device 128 is attached to bus 122 for controlling audio output. A display 124 is also attached to bus 122 for providing visual, tactile or other graphical representation formats. Display 124 can include both non-transparent surfaces, such as monitors, and transparent surfaces, such as headset sunglasses or vehicle windshield displays.

A keyboard 126 and cursor control device 130, such as mouse, trackball, or cursor direction keys, are coupled to bus 122 as interfaces for user inputs to computer system 100.

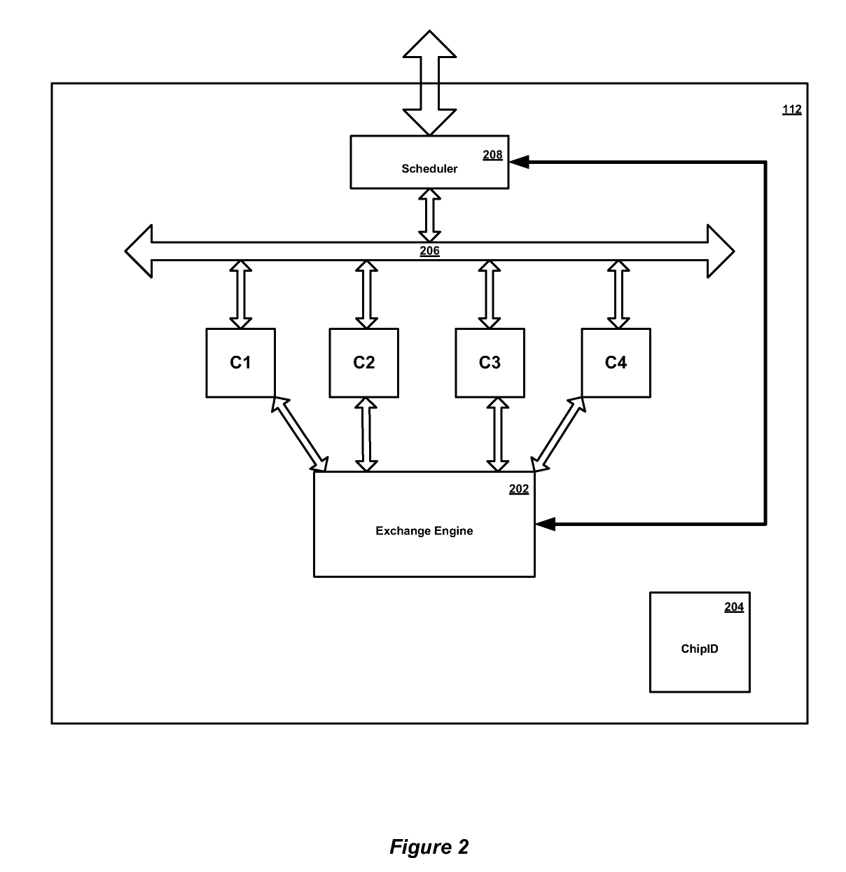

Reference now being made to FIG. 2, a diagram is shown illustrating the processor 112 of FIG. 1 in greater detail according to a preferred embodiment of the present invention. It should be noted that although the preferred embodiment of the present invention uses a processor 112, the present invention is not limited to this embodiment, but is equally applicable to any device that has multiple equivalent functional units where some of the functional units are reserved for swapping with non-reserved functional units as a result of failure or usage as explained below.

Processor 112 is a multi-core processor having numerous components whose function and operation are well known and understood. Consequently, only those components that are deemed to require further explanation as they are used in the present invention are illustrated and discussed. Processor 112 includes a scheduler 208, cores C1 to C4, chip Identification (Chip ID) 204, and Exchange engine 202.

Scheduler 208 represents the interface to bus 122 and is responsible for managing and assigning tasks/instructions to one or more of the cores C1-C4 as they are received.

The Chip ID 204 stores and retains a unique identifier, such as a number or the like and can be, for example, fuses, e-fuses, or ROM.

Each core C1-C4 communicates with scheduler 208 using an internal bus such as internal bus 206. Each core C1-C4 also communicates with the Exchange engine 202 via a bus, point-to-point (as shown), or other means. In the preferred embodiment of the present invention, processor 112 is shown as having four cores C1-C4. This embodiment is not intended to limit the number of cores that can reside within processor 112 but as a convenient means for explaining the present invention. In fact, the number of cores that can reside in processor 112 can be numerous and are typically dictated by the design of the computer system 100.

The Exchange engine 202 is used for selecting an initial set of cores C1-C4 for operation while keeping the non-selected cores C1-C4 inoperable until a predetermined amount of usage of the selected cores C1-C4 has occurred or one or more of the selected cores C1-C4 has failed. In the preferred embodiment of the present invention, the selected cores and non-selected cores have a one-to-one relationship. However, it should be realized that depending upon the particular reliability and lifetime requirements for the computer system 100, the selected and non-selected cores can have any other type of relationship that is necessary to meet these requirements (e.g., one selected three non-selected). The predetermined time period can be based on numerous factors such as a statistical analysis of the total power-on hours, clock cycles processed, and the like.

In the preferred embodiment of the present invention, the Exchange engine 202 tracks the elapsed time period since the initial cores C1-C4 have been selected and swap the initial selected cores C1-C4 with the non-selected cores C1-C4 when a predetermined amount of usage has occurred or a selected core(s) C1-C4 has failed. In an alternative preferred embodiment of the present invention, the Exchange engine 202 resides in the computer system 100 as firmware, hardware, software or any combination thereof.

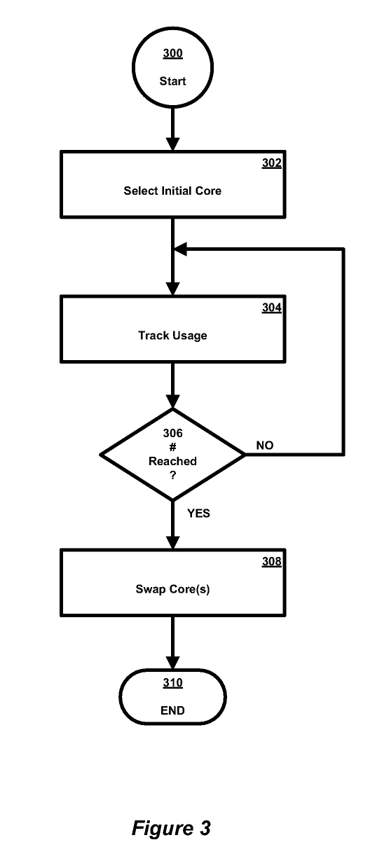

Reference now being made to FIG. 3, a flow chart is shown illustrating the method for managing the activation of cores C1-C4 when a predetermined amount of usage has occurred according to the teachings of a preferred embodiment of the present invention. In a preferred embodiment of the present invention, the processor 112 is embodied in a single integrated circuit package. In addition, the computer system 100 is designed such that it can use some or all of the cores residing in processor 112 depending upon performance and reliability requirements. In order to explain the operation of the Exchange engine 202, it will be assumed that computer system 100 only requires the use of two cores.

The method begins upon the Exchange engine 202 selecting one or more cores C1-C4 (C1 and C2 in this example) for initial operation (Steps 300-302). During the operation of computer system 100, the Exchange engine 202 monitors the usage of the selected cores (C1 and C2) (e.g., power-on hours, clock cycles or similar means for measuring usage). In the preferred embodiment of the present invention, the usage is based on power-on hours (Step 304).

Once the selected core(s) (C1 and C2) have operated for a predetermined number of power-on hours (Step 306), the Exchange engine 202 makes the non-selected cores (C3 and C4) operative and the initial selected cores (C1 and C2) inoperative (Step 308). Depending upon the particular design of the computer system 100 and processor 112, the swapping of the cores can occur by assigning tasks in progress, upon completion of tasks in progress, or when the system is powered down (Steps 308-310).

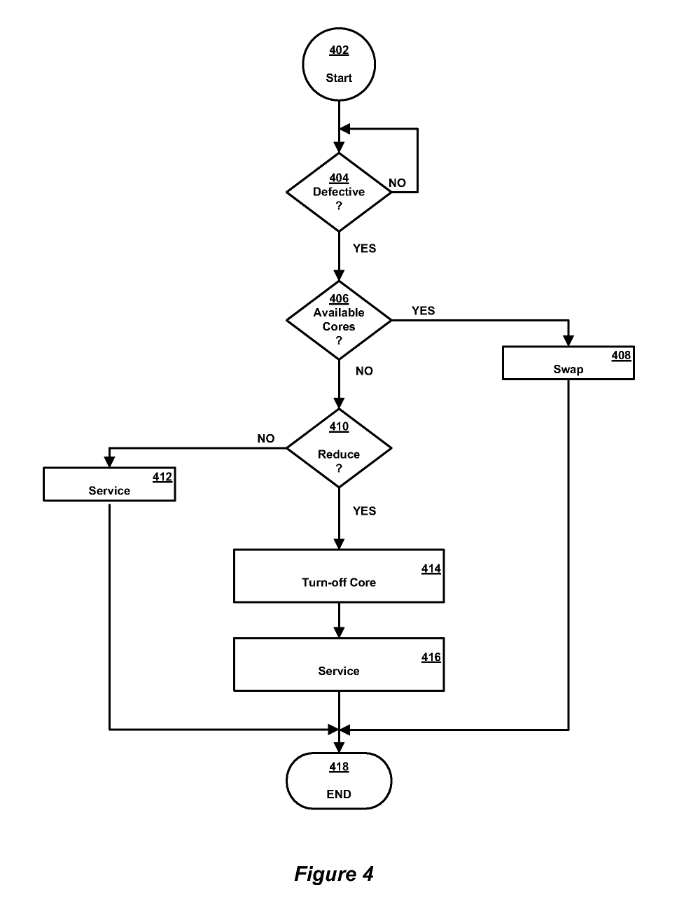

It should be noted that the number of non-selected cores C1-C4 that are available for this swap operation could be diminished by the failure of one or more of the selected cores C1-C4 prior to the expiration of the predetermined usage amount as explained in connection with FIG. 4. In this case, the Exchange engine 202 would swap any remaining non-selected cores C1-C4 with the selected cores C1-C4.

Reference now being made to FIG. 4, a flow chart is shown illustrating the method for managing the activation of cores C1-C4 of FIG. 2 when one of the cores C1-C4 has failed according to the teachings of a preferred embodiment of the present invention. The method begins upon the detection or notification of the failure of one of the selected cores C1-C4 (Steps 402-404). The detection can be performed by the Exchange engine 202 or another component of the computer system 100.

If any non-selected cores C1-C4 are available for activation, then the Exchange engine 202 activates a non-selected core C1-C4 and de-activates the failing core C1-C4 (Steps 406-408). Depending upon the particular design of the computer system 100 and processor 112, the swapping of the cores can occur by assigning tasks in progress, upon completion of tasks in progress, or when the system is powered down (Steps 308-310).

If, however, there are no non-selected cores C1-C4 available, then the Exchange engine 202 is either already aware or queries the computer system 100 to determine whether it can operate sufficiently with a reduction in the number of operable cores C1-C4 (Step 410).

If the computer system 100 can operate on a reduced number of cores C1-C4, then the failing core is taken out of operation and a service notification is provided (Steps 414-418).

If, however, the computer system 100 is not able to operate on a reduced number of cores C1-C4, then a service notification is provided and the computer system 100 is shut down (Steps 412 and 418).

It is thus believed that the operation and construction of the present invention will be apparent from the foregoing description. While the method and system shown and described has been characterized as being preferred, it will be readily apparent that various changes and/or modifications could be made without departing from the spirit and scope of the present invention as defined in the following claims.

What is claimed is:

1. A computer-implemented method of swapping a core in an integrated circuit having multiple cores, the method comprising the steps of:
selecting one or more of the cores for initial operation, wherein at least one remaining core is not operating;
tracking the use of the selected core(s); and
swapping the selected core(s) with the remaining non-selected core(s) after the tracked use has exceeded a predetermined number.

2. The method of claim 1 wherein the step of tracking the use of the selected core(s) includes the step of:
tracking a number of power-on hours that the selected core(s) has been operating.

3. The method of claim 2 wherein the step of swapping the selected core(s) includes the step of:
swapping the selected core(s) with the remaining non-selected core(s) after the tracked number of power-on hours for the selected core(s) exceeds the predetermined number.

4. The method of claim 3 wherein the predetermined number is based on the anticipated number of power-on hours that the selected core(s) will operate without failing.

5. The method of claim 1 wherein the step of tracking the use of the selected core(s) includes the step of:
tracking the number of clock cycles that the selected core(s) has received.

6. The method of claim 5 wherein the step of swapping the selected core(s) includes the step of:
swapping the selected core(s) with the remaining non-selected core(s) after the tracked number of clock cycles for the selected core(s) exceeds the predetermined number.

7. The method of claim 6 wherein the predetermined number is based on the anticipated number of clock cycles that the selected core(s) will operate without failing.

8. An apparatus for using multiple cores in an integrated circuit, the apparatus comprising:
means for selecting one or more of the cores for initial operation;
means for tracking the use of the selected core(s); and
means for swapping the selected core(s) with the remaining non-selected core(s) after the tracked use has exceeded a predetermined number.

9. The integrated circuit of claim 1 wherein the means for tracking the use of the selected core(s) includes:
means for tracking the number of power-on hours that the selected core(s) has been operating.

10. The apparatus of claim 9 wherein the means for swapping the selected core(s) includes:
means for swapping the selected core(s) with the remaining non-selected core(s) after the tracked number of power-on hours for the selected core(s) exceeds a predetermined number.

11. The apparatus of claim 8 wherein the predetermined number is based on the anticipated number of power-on hours that the selected core(s) will operate without failing.

12. The apparatus of claim 8 wherein the means for tracking the use of the selected core(s) includes:
means for tracking the number of clock cycles that the selected core(s) has received.

13. The apparatus of claim 12 wherein the means for swapping the selected core(s) includes:
means for swapping the selected core(s) with the remaining non-selected core(s) after the tracked number of clock cycles for the selected core(s) exceeds a predetermined number.

14. The apparatus of claim 13 wherein the predetermined number is based on the anticipated number of clock cycles that the selected core(s) will operate without failing.

15. A computer program product comprising a computer usable medium having computer usable program code for using multiple cores in an integrated circuit, the computer usable program code comprising:
computer usable program code for selecting one or more of the cores for initial operation;
computer usable program code for tracking the use of the selected core(s); and
computer usable program code for swapping the selected core(s) with the remaining non-selected core(s) after the tracked use has exceeded a predetermined number.

16. The computer program product of claim 15 wherein the computer usable program code for tracking the use of the selected core(s) includes:
computer usable program code for tracking the number of power-on hours that the selected core(s) has been operating.

17. The computer program product of claim 16 wherein the computer usable program code for swapping the selected core(s) includes:
computer usable program code for swapping the selected core(s) with the remaining non-selected core(s) after the tracked number of power-on hours for the selected core(s) exceeds a predetermined number.

18. The computer program product of claim 15 wherein the predetermined number is based on the anticipated number of power-on hours that the selected core(s) will operate without failing.

19. The computer program product of claim 15 wherein the computer usable program code for tracking the use of the selected core(s) includes:
computer usable program code for tracking the number of clock cycles that the selected core(s) has received.

20. The computer program product of claim 19 wherein the computer usable program code for swapping the selected core(s) includes:
computer usable program code for swapping the selected core(s) with the remaining non-selected core(s) after the tracked number of clock cycles for the selected core(s) exceeds a predetermined number.
